(19) United States
(12) Patent Application Publication
(10) Pub. No.: US 2025/0362029 A1
(43) Pub. Date: Nov. 27, 2025

(54) COOKING APPLIANCE WITH BROWNING ASSISTANCE MONITOR

(71) Applicant: WHIRLPOOL CORPORATION, BENTON HARBOR, MI (US)

(72) Inventors: Alessandro Gigante, Varese (IT); Vaishali Nandy, Kalamazoo, MI (US); Marco Casucci, Varese (IT); Stefano Masi, Varese (IT); Colleen Marie Rodriguez, Ann Arbor, MI (US)

(73) Assignee: WHIRLPOOL CORPORATION, BENTON HARBOR, MI (US)

(21) Appl. No.: 18/670,970

(22) Filed: May 22, 2024

(51) Int. Cl. F24C 7/08

(52) U.S. Cl. CPC F24C 7/085; F24C 7/086; F24C 7/087

(57) ABSTRACT

A cooking appliance includes a body defining a cooking chamber and a sensor monitoring the cooking chamber. A control system is configured to monitor an item of food within the cooking chamber with the sensor, and classify a browning of the item of food from a list of classifications including at least correct browning and incorrect browning. If the item of food is classified as incorrect browning, one of a cycle alert is generated to a user to change an aspect of a cooking cycle, a positional alert is generated to the user to change a position of the item of food within the cooking chamber, or a signal is generated to automatically change the aspect of the cooking cycle.

### FIELD OF THE DISCLOSURE

The present disclosure generally relates to a cooking appliance and, more particularly, a control and monitoring system of the cooking appliance that monitors browning of food within a cooking cavity.

### BACKGROUND

Some cooking appliances incorporate assistive cooking technologies. These assistive cooking technologies may implement pre-saved cooking cycles specifically designed for different types of food. However, assistive cooking technologies are typically pre-saved or programmed instructions that do not provide dynamic recommendations or corrective actions. For example, some types of food are optimally cooked with browning on an exterior surface. Proper browning provides a more appetizing color, a rich flavor, and can seal in moisture.

Accordingly, the present disclosure relates to a control and monitoring system of the cooking appliance that monitors browning of food within a cooking cavity.

### SUMMARY OF THE DISCLOSURE

According to one aspect of the present disclosure, a cooking appliance includes a body defining a cooking chamber and a sensor monitoring the cooking chamber. A control system is configured to monitor an item of food within the cooking chamber with the sensor, and classify a browning of the item of food from a list of classifications including at least correct browning and incorrect browning. If the item of food is classified as incorrect browning, one of a cycle alert is generated to a user to change an aspect of a cooking cycle, a positional alert is generated to the user to change a position of the item of food within the cooking chamber, or a signal is generated to automatically change the aspect of the cooking cycle.

According to another aspect of the present disclosure, a cooking appliance includes a body defining a cooking chamber, an imager module oriented towards the cooking chamber, and a user interface for selecting a cooking cycle. A control system is configured to receive the cooking cycle selected by the user interface, and receive a classification of an item of food from the cooking cycle selected by the user interface or based on images captured by the imager module. An optimal cooking cycle is selected based on the classification of the item of food and the optimal cooking cycle is compared with the cooking cycle selected by the user interface. If the comparison between the optimal cooking cycle and the cooking cycle selected by the user interface is outside of a predetermined threshold associated with browning, one of a cycle alert to a user to change an aspect of a cooking cycle or a signal to automatically change the aspect of the cooking cycle is generated.

According to yet another aspect of the present disclosure, a cooking appliance includes a body defining a cooking chamber with at least one rack for holding an item of food. An imager module is oriented towards the rack. A control system is configured to monitor the item of food within the cooking chamber with image data captured by the imager module, and classify a browning of the item of food from a list of classifications including at least correct browning and uneven browning. If the item of food is classified as uneven browning, a positional alert is generated to the user to change a position of the item of food within the cooking chamber.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front view of a cooking appliance with a grease monitoring system, according to an aspect of the present disclosure;

FIG. 2 is a front view of a cooking chamber with a grease monitoring system, according to an aspect of the present disclosure;

FIG. 3 is a front perspective view of an item of food browning within a cooking chamber, according to an aspect of the present disclosure;

FIG. 4 is a schematic view of a control system for a cooking appliance, according to an aspect of the present disclosure;

FIG. 5 is a schematic view of a food classification dictionary, according to an aspect of the present disclosure;

FIG. 6 is a schematic view of a browning interpretation module, according to an aspect of the present disclosure;

FIG. 7 illustrates a first method of monitoring a cooking chamber for browning conditions of an item of food, according to an aspect of the present disclosure; and

FIG. 8 illustrates a second method of predicting correct browning conditions of a cooking cycle, according to an aspect of the present disclosure.

The components in the figures are not necessarily to scale, emphasis instead being placed upon illustrating the principles described herein.

### DETAILED DESCRIPTION

The present illustrated embodiments reside primarily in a control and monitoring system of a cooking appliance that monitors browning of food within a cooking cavity. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

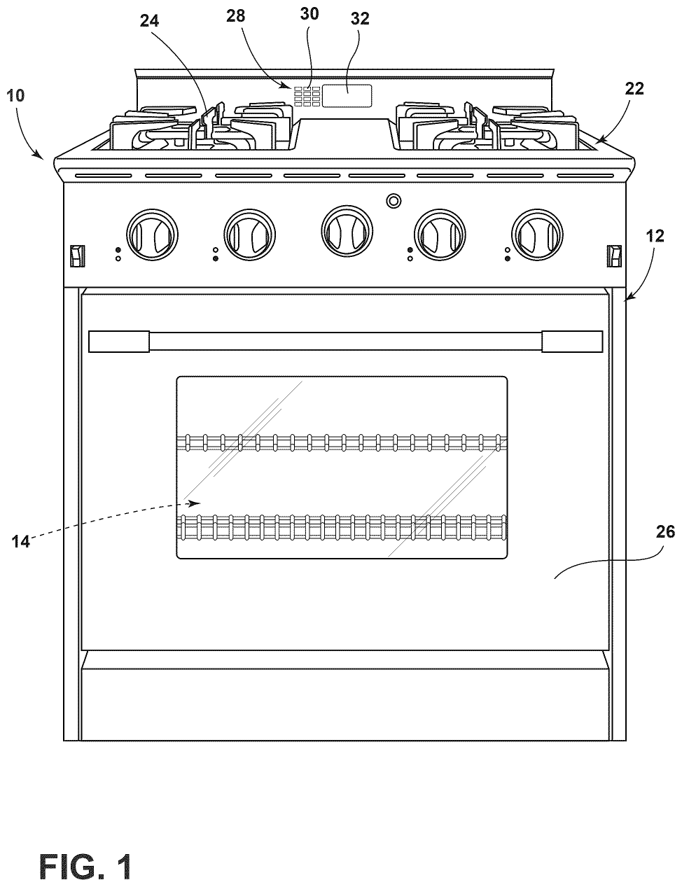

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a cooking appliance. The cooking appliance 10 includes a body 12 defining a cooking chamber 14 and a sensor 16 monitoring the cooking chamber 14. A control system 100 (e.g., a processor 104) is configured to monitor an item of food 18 within the cooking chamber 14 with the sensor 16, and classify a browning of the item of food 18 from a list of classifications including at least correct browning and incorrect browning. If the item of food 18 is classified as incorrect browning, one of a cycle alert is generated to a user to change an aspect of a cooking cycle, a positional alert is generated to the user to change a position of the item of food within the cooking chamber, or a signal is generated to automatically change the aspect of the cooking cycle.

Generally speaking, the systems, methods, and functions described herein assist the user while cooking the item of food 18 by ensuring correct browning of the item of food 18 via feedback from the sensor 16. Incorrect browning of the item of food 18 can occur based on the aspect of the cooking cycle, a characteristic of the item of food 18, and the position of the item of food 18 within the cooking chamber 14. As it relates to the cooking cycle, a cooking type (e.g., baking, broiling, convection baking, and the like), an internal temperature within the cooking chamber 14, air circulation within the cooking chamber 14, and the time that the item of food 18 is heated can affect the browning of the item of food 18. Therefore, it should be appreciated that the cycle alert or the signal that automatically changes an aspect of the cooking cycle may correspond to requesting that a user manually adjust or automatically adjust (e.g., via the control system 100) one or more of the cooking type, the internal temperature of the cooking chamber 14, or the time that the cooking chamber 14 is heated. As it relates to the characteristic of the item of food 18, quantity and the number additional items of food being contemporaneously cooked can impact a rate and uniformness of browning. Therefore, in some embodiments, the cycle alert or the signal that automatically changes an aspect of the cooking cycle may correspond at least in part of a detection (e.g., via the sensor 16) of the quantity of the item of food 18 and the number additional items of food being contemporaneously cooked. As it relates to the position of the item of food 18 (e.g., associated with the positional alert), the position of the item of food 18 may relate to the location within the cooking chamber 14 and/or the orientation that the item of food 18 is placed within the cooking chamber 14. Therefore, by monitoring the aspect of the cooking cycle, the characteristic of the item of food 18, and/or the position of the item of food 18, the cooking appliance 10 can ensure correct browning automatically and/or with manual adjustments (e.g., via alerts).

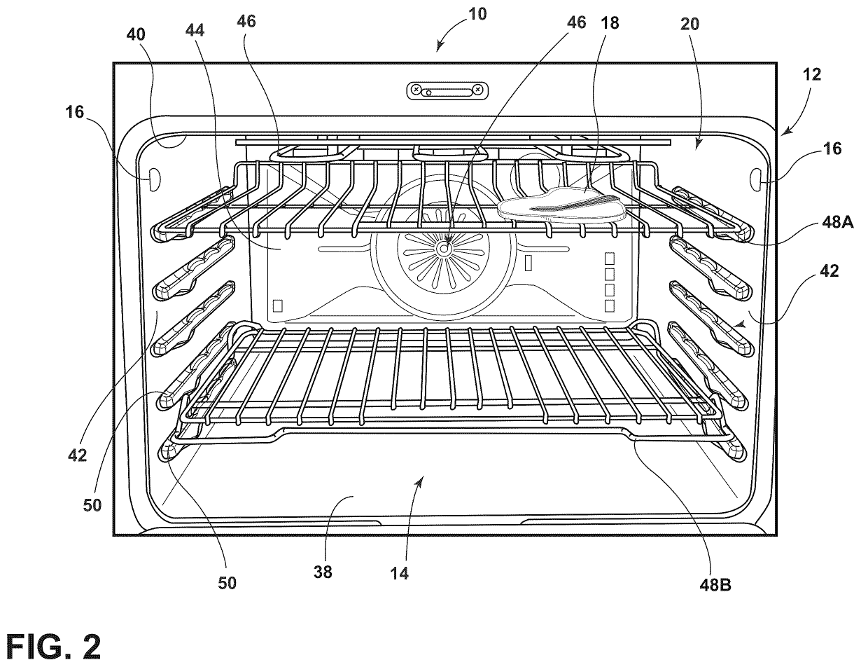

With reference now to FIGS. 1 and 2, the cooking appliance 10 may employ a variety of heating technologies, such as induction heating, electric heating, gas heating, and heating that employs all fuel types. The cooking appliance 10 may also provide different cooking cycle options, for example, at different temperatures, baking, broiling, convection baking, air circulation, and/or different cooking times. In some embodiments, the cooking appliance 10 may include a cooktop 22 including one or more burners 24 that employ any of the above-referenced heating technologies. The cooking chamber 14 may be accessed via a door 26 that includes an open position and a closed position. The cooking appliance may further include a user interface 28 that includes user inputs 30, such as touchpads, buttons, knobs, speakers, voice recognition functionality, and/or the like. The user interface 28 may further include a user communication module 32, such as a display, a speaker, and/or one or more lighting modules that effectuate alerting and/or notifying the user. In some embodiments, the user interface 28 may further include a device communication module 34 that wirelessly connects to a mobile device 36, such as a mobile phone, a tablet, and/or the like. In this manner, when an alert or notification is generated, it may be generated locally via the user communication module 32 and/or remotely via communication between the device communication module 34 and the mobile device 36.

With continued reference to FIGS. 1 and 2, the cooking chamber 14 is generally defined by a floor 38 and a ceiling 40 spaced by sidewalls 42 and a back wall 44. One or more heating elements 46 are generally proximate the back wall 44 and/or the ceiling 40. The one or more heating elements 46 may include multiple heating elements 46 corresponding to baking, broiling, convection baking, and/or the like. The cooking appliance 10 typically includes one or more racks 48A, 48B (e.g., a top rack 48A and a bottom rack 48B) for placing the item of food 18. The cooking chamber 14 (e.g., the sidewalls 42 and/or back wall 44) may define rack holding structures 50 for locating the one or more racks 48A, 48B at different rack levels relative to a floor 38 and ceiling 40. The rack holding structures 50 may include projections or recesses that hold one of the racks 48A, 48B. Accordingly, the position of the item of food 18 may relate to the location within the cooking chamber 14 (e.g., moving the item of food 18 relative to one rack 48A, 48B and/or moving the item of food 18 to a different rack level). Therefore, by monitoring the position of the item of food 18, the cooking appliance 10 can ensure correct browning through positional alerts. In this manner, correct browning of the item of food 18 for an appetizing color, a rich flavor, and sealed in moisture is achieved.

With reference now to FIG. 2, in some embodiments, the sensor 16 may be located within the cooking chamber 14, outside of the cooking chamber 14 and behind one or more of the floor 38, the ceiling 40, the sidewalls 42, and/or the back wall 44 (e.g., and oriented towards the cooking chamber 14 with an exposure hole and/or transparent element), and/or outside of the cooking appliance 14 (e.g., on the door 26). As used herein, the term “sensor” may refer to one or more of any type of sensing module that is capable of extracting data for the control system 100 (e.g., the processor 104) to at least one of classify the item of food 18 and detect grease generation (e.g., splattering or dripping). Further, the sensor 16 may include two or more sensors located in different locations relative to the cooking chamber 14 to ensure line-of-sight from different orientations of the item of food 18. In this manner, the size, shape, and quantity of the item of food 18 can be determined through the principles of stereovision or other depth extracting, size determining, methodologies. As will be described in greater detail below, by determining the size, shape, and quantity, the control system 100 (e.g., the processor 104) may be able to classify the item of food 18 (e.g., steak, chicken, pizza, bread etc.).

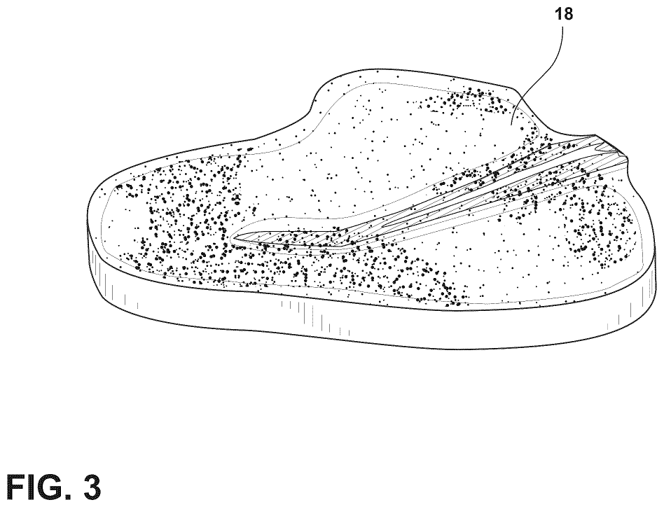

With reference now to FIGS. 2 and 3, the sensor 16 may be configured as one or more imager modules that capture image data 54 within the cooking chamber 14. In some embodiments, the one or more imager modules may include a thermal camera that detects infrared energy (heat) and converts it into image data 54. The infrared energy captured by the thermal camera may be utilized to determine the current temperature on an exterior of the item of food 18. In some embodiments, the one or more imager modules may be used in conjunction with one or more light sources. For example, the one or more light sources may be configured to generate light in a visible or non-visible spectrum (e.g., infrared or near infrared spectrum) and the imager module may be configured to capture image data 54 in the visible or non-visible spectrum associated with the light source. The one or more imager modules may be configured to gather image data in any number of frames-per-second, such that classification and detection of the browning of the item of food is near real-time to prevent and/or minimize any delayed alerts or signals. The control system 100 (e.g., the processor 104) may be configured to trigger the one or more imager modules upon an event, such as when the door 26 is opened, interaction with the user interface 28 (e.g., user inputs 30 or through the mobile device 36), or when the heating element 46 is energized (e.g., preheated). Further, it should be appreciated that the user interface 28 may optionally include selections for a user to select a specific cooking cycle and/or input a classification of the type of the item of food 18.

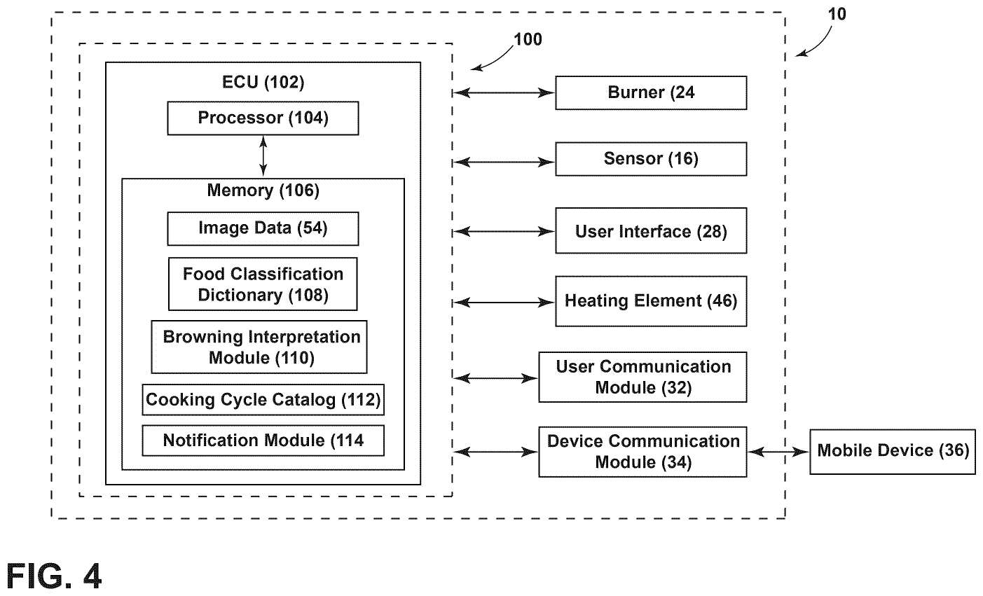

With reference now to FIG. 4, the control system 100 is schematically illustrated. The control system 100 may include an electronic control unit (ECU) 102. The ECU 102 may include the processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid-state) memory, other non-transitory storage mediums, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the control system 100. The one or more sensors 16 (e.g., imager module and light source), the user interface 28, and the heating element 46 may therefore be controlled by and/or receive instructions from the ECU 102. The memory 106 may therefore include the image data 54, a food classification dictionary 108, a browning interpretation module 110, a cooking cycle catalog 112, and a notification module 114.

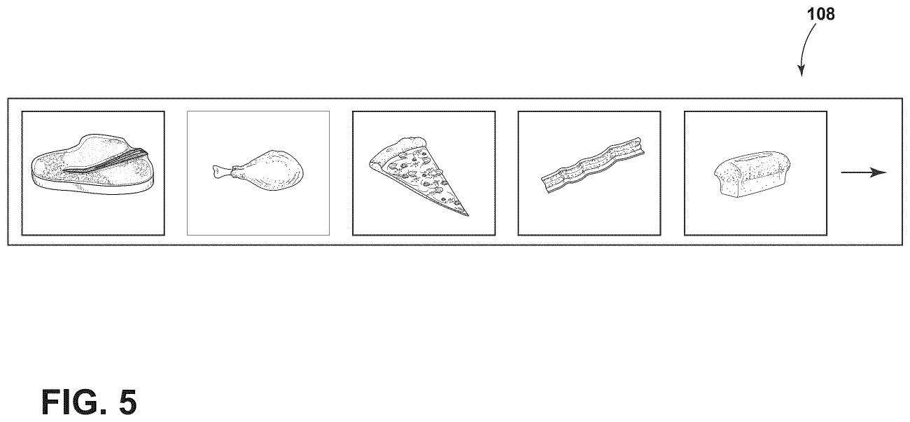

With reference now to FIGS. 4 and 5, the food classification dictionary 108 may include pre-saved food characteristics relating to shape, color, and size that can compared to characteristics of the food item 18 that are extracted by the image data 54. For example, and while not an exhaustive list, steaks, burgers, other types of meat, pizza, bread, and/or other types of food that benefit from browning typically have defining characteristics that can be perceived and/or extracted by the control system 100 (e.g., the processor 104). However, it is contemplated that the user may, alternatively to or in addition to the food classification dictionary, utilize the user interface 28 to manually classify the item of food. Further, the food classification dictionary 108 may include positional parameter instructions, such as detecting the location and orientation of the food item 18 with respect to the sensor 16 (e.g., imager module). The positional parameter instructions may include instructions for determining a location of the item of food 18 relative to one rack 48A, 48B and/or rack level. In some embodiments, the pre-saved food characteristics may include multiple orientations saved together or categorized in discrete files/memory partitions. By comparing the extracted defining characteristics with the pre-saved characteristics, the food item 18 can be classified to determine correct and incorrect browning.

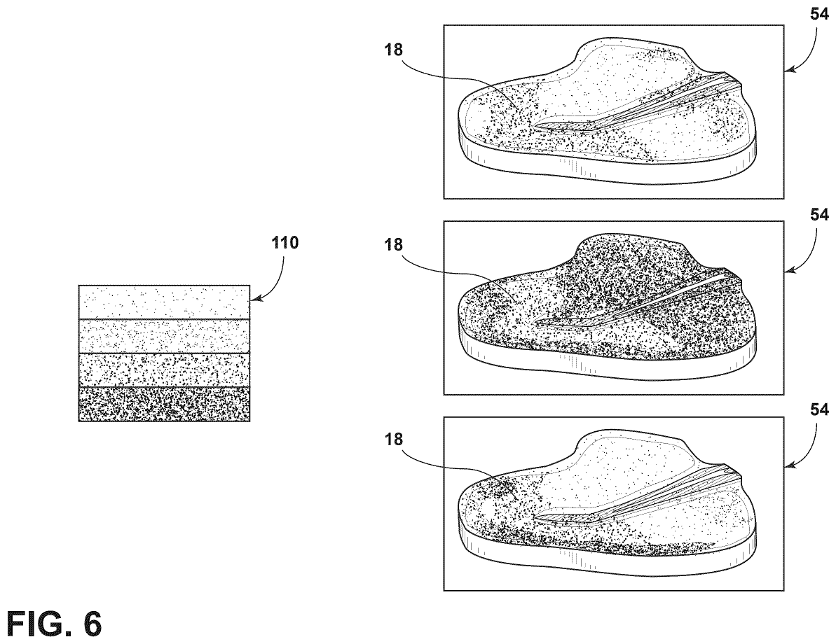

With reference now to FIGS. 4 and 6, the control system 100 (e.g., the processor 104) may utilize the browning interpretation module 110. The incorrect browning classification may include a premature browning, a late browning, and an uneven browning classification. It should be appreciated that the correct browning classification and incorrect browning classification may be unique to one or more classifications of the item of food 18. In this manner, the control system 100 (e.g., the processor 104) may select browning classification guidelines based on the classification of the item of food 18. The browning interpretation module 110 may, therefore, include instructions for the control system 100 (e.g., the processor 104) to, based on the classification of the item of food 18, initially select browning classification guidelines. The browning classification guidelines include attributes or characteristics of the item of food 18 that can be extracted by the image data 54. For example, a color of the item of food 18, a change in color of the item of food 18 during a cooking cycle or over a period of time during the cooking cycle, surface texture of the item of food 18, surface sheen of the item of food 18, the like, and/or combinations thereof.

The cooking cycle catalog 112 may include pre-programmed or saved cooking cycles that relate to different temperatures, baking, broiling, convection baking, air circulation, and/or different cooking times. In addition or alternatively to the pre-programmed or saved cooking cycles, it should be appreciated that the user may manually select parameters of a cooking cycle and or modify the pre-programmed or saved cooking cycles. The cooking cycle catalog 112 may further include adjustment parameters to automatically adjust the cooking cycle based on, for example, feedback from the sensor 16. The adjustment parameters may cause the control system 100 (e.g., the processor 104) to automatically or generate an alert of a user to manually change one or more of the temperature, the cooking type, air circulation, and time. The cooking cycle catalog 112 can be used to understand if the currently implemented cooking cycle is appropriate. Information in the cooking cycle catalog 112 can be used to interpolate among new settings. For example, if a user desires to cook a pizza with correct browning of the crust, there may be options (e.g., pre-programmed or saved cooking cycles) where the temperature setting is at 250° C. for 10 minutes of a temperature setting of 280° C. for 8 minutes. If the user sets the temperature at 265° C. the control system 100 (e.g., the processor 104) may be configured to extrapolate an optimal predictive cooking cycle that includes a set time around, for example, 9 minutes. In such scenarios, the control system 100 (e.g., the processor 104) can automatically adjust or send alerts if the extrapolation does not match what is being manually selected by the user. In this manner, the control system 100 (e.g., the processor 104) may be configured to automatically adjust or send alerts when the initial cooking cycle is chosen by a user and before classification of the browning. The optimal predictive cooking cycle may include threshold parameters, based on user preference or another characteristic of the chosen cooking cycle. Referring again to the above example, the control system 100 (e.g., the processor 104) may be configured to delay automatic adjustment or alerts if the chosen cooking cycle is within a predetermined time threshold (e.g., 30 seconds) of the optimal predictive model (e.g., 8 ½ to 9 ½ minutes).

With continued reference to FIGS. 4 and 6, non-uniform or uneven browning may result from over broiling causing over browning on a central area of the item of food 18, too much air circulation causing higher dry out and browning along the air path (usually on the edges of the item of food 18 or the edges of a food tray), or the positioning of the item of food 18. If detected, the control system 100 (e.g., the processor 104) may modify the cooking cycle (e.g., from broil to convection or vice versa), generate an alert to change rack level (e.g., where the further the item of food 18 is from the broiling element, the more homogenous the broiling and browning is), change the position of the item of food 18 on the rack 48A, 48B, and/or stir the item of food 18 if appropriate.

Regardless of the optimal predictive models, the control system 100 (e.g., the processor 104) may continually receive feedback from the sensor 16 to ensure correct browning throughout the cooking cycle. For example, if the browning classification is one of premature browning or late browning, the classification of the item of food 18 (e.g., determined automatically based on the sensor 16 or input by the user) can be utilized. More particularly, the control system 100 (e.g., the processor 104) may predict if the cooking type (e.g., a broiling phase) is occurring too early or too late for that specific classification and/or quantity of the item of food 18. Based on feedback from the sensor 16, the control system 100 (e.g., the processor 104) may be configured to detect a browning color change and compare it with the timing needed for that classification and/or quantity of the item of food 18. If the browning is happening too early or too late, then the control system 100 (e.g., the processor 104) may generate an alert to advise the user to decrease or increase the temperature for more balanced cooking, to change the cooking type, and/or the like to align with the optimal predictive cooking cycle to offset the current direction (e.g., more or less broil and/or more or less cavity air flow).

The notification module 114 may include parameters on when the control system 100 (e.g., the processor 104) generates the alert the user. The parameters may include several independent conditions on when to generate the alert and the alert may be different based on the independent condition detected. For example, in the event that the item of food is classified as incorrect browning or a cooking cycle is selected that is outside of the optimal predictive model, the control system 100 (e.g., the processor 104) may generate one of a cycle alert to a user to change an aspect of a cooking cycle, a positional alert to the user to change a position of the item of food within the cooking chamber, or a signal to automatically change the aspect of the cooking cycle. For example, the alerts may be distinct by any of a combination of auditory (e.g., frequency, amplitude, vocal commands) or visual (e.g., via graphics, colors, or pulsing of light via user communication module 32) distinctions. Further, these alerts may be carried out (e.g., via device communication module 34) through the mobile device 36.

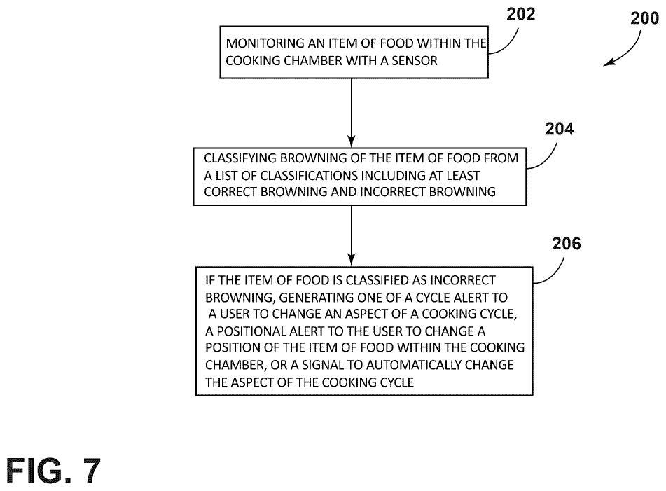

With reference now to FIG. 7, a method 200 of monitoring a cooking chamber for browning conditions of an item of food is illustrated. In some embodiments, the first method 200 may be carried out by, for example, the cooking appliance 10 and control system 100 depicted in FIGS. 1-6. The first method 200 includes, at step 202, monitoring an item of food within the cooking chamber with a sensor. At step 204, the first method 200 may include classifying browning of the item of food from a list of classifications including at least correct browning and incorrect browning. At step 206, the first method 200 may include, if the item of food is classified as incorrect browning, generating one of a cycle alert to a user to change an aspect of a cooking cycle, a positional alert to the user to change a position of the item of food within the cooking chamber, or a signal to automatically change the aspect of the cooking cycle. The monitoring, classifying, and subsequent alerts and signals provided in method 200 may include those described in relation to the cooking appliance 10.

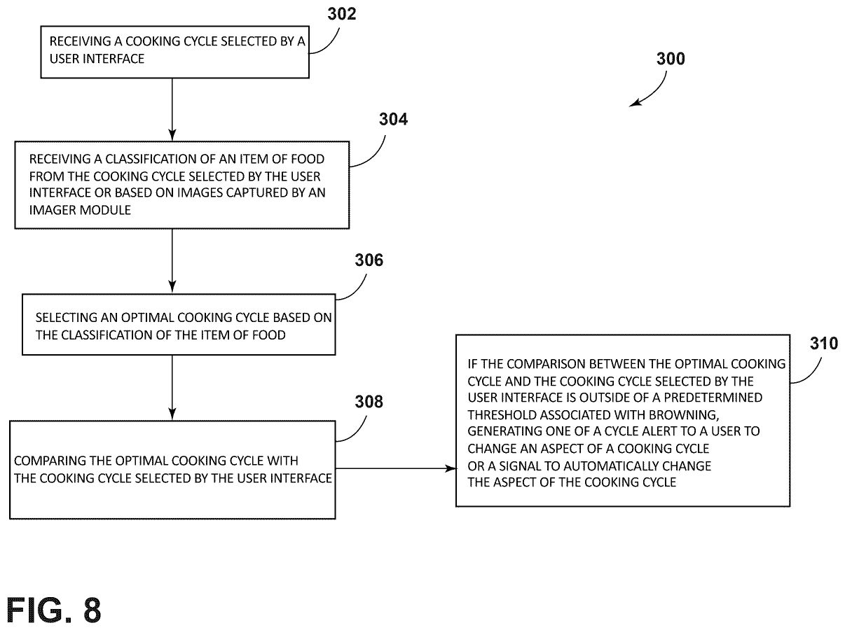

With reference now to FIG. 8, a second method 300 of predicting correct browning conditions of a cooking cycle is illustrated. Similar to the first method 200, the second method 300 may be carried out by, for example, the cooking appliance 10 and control system 100 depicted in FIGS. 1-6. The second method 300 includes, at step 302, receiving a cooking cycle selected by a user interface. At step 304, the second method 300 may include receiving a classification of an item of food from the cooking cycle selected by the user interface or based on images captured by an imager module. At step 306, the second method 300 may include selecting an optimal cooking cycle based on the classification of the item of food. At step 308, the second method 300 may include, comparing the optimal cooking cycle with the cooking cycle selected by the user interface. At step 310, the second method 300 may further include, if the comparison between the optimal cooking cycle and the cooking cycle selected by the user interface is outside of a predetermined threshold associated with browning, generating one of a cycle alert to a user to change an aspect of a cooking cycle or a signal to automatically change the aspect of the cooking cycle. The monitoring, classifying, and subsequent alerts and signals provided in method 300 may include those described in relation to the cooking appliance 10. In some embodiments, the first method 200 may be triggered during the cooking cycle in method 300.

The disclosure herein is further summarized in the following paragraphs and is further characterized by combinations of any and all of the various aspects described therein.

According to one aspect of the present disclosure, a cooking appliance includes a body defining a cooking chamber and a sensor monitoring the cooking chamber. A control system is configured to monitor an item of food within the cooking chamber with the sensor, and classify a browning of the item of food from a list of classifications including at least correct browning and incorrect browning. If the item of food is classified as incorrect browning, one of a cycle alert is generated to a user to change an aspect of a cooking cycle, a positional alert is generated to the user to change a position of the item of food within the cooking chamber, or a signal is generated to automatically change the aspect of the cooking cycle.

According to another aspect, a control system is configured to generate a cycle alert to a user to change an aspect of the cooking cycle.

According to yet another aspect, an aspect of a cooking cycle includes increasing a temperature within a cooking chamber.

According to still yet another aspect, an aspect of a cooking cycle includes decreasing a temperature within a cooking chamber.

According to another aspect, a control system is configured to generate a positional alert to a user to change a position of an item of food within a cooking chamber.

According to yet another aspect, a positional alert further includes a recommendation to change a rack level of an item of food.

According to still yet another aspect, a positional alert includes a recommendation to change a position of an item of food on a rack.

According to another aspect, a control system is configured to generate a signal to automatically change an aspect of a cooking cycle.

According to yet another aspect, a signal includes instructions to automatically increase a temperature within a cooking chamber.

According to still yet another aspect, a signal includes instructions to automatically decrease a temperature within a cooking chamber.

According to another aspect, an incorrect browning classification includes premature browning and late browning.

According to yet another aspect, an incorrect browning classification includes uneven browning.

According to still yet another aspect, if an item of food is classified as uneven browning, a control system is configured to generate a positional alert to a user to change a position of an item of food within a cooking chamber.

According to another aspect of the present disclosure, a cooking appliance includes a body defining a cooking chamber, an imager module oriented towards the cooking chamber, and a user interface for selecting a cooking cycle. A control system is configured to receive the cooking cycle selected by the user interface, and receive a classification of an item of food from the cooking cycle selected by the user interface or based on images captured by the imager module. An optimal cooking cycle is selected based on the classification of the item of food and the optimal cooking cycle is compared with the cooking cycle selected by the user interface. If the comparison between the optimal cooking cycle and the cooking cycle selected by the user interface is outside of a predetermined threshold associated with browning, one of a cycle alert to a user to change an aspect of a cooking cycle or a signal to automatically change the aspect of the cooking cycle is generated.

According to another aspect, a cycle alert to a user includes a recommendation to adjust a time of a cooking cycle.

According to yet another aspect, a cycle alert to a user includes a recommendation to adjust a temperature within a cooking chamber.

According to yet another aspect, a signal to automatically change an aspect of a cooking cycle includes at least one of adjusting a time of the cooking cycle, adjusting a temperature within a cooking chamber, adjusting an airflow within the cooking chamber, or selecting a cooking type.

According to yet another aspect of the present disclosure, a cooking appliance includes a body defining a cooking chamber with at least one rack for holding an item of food. An imager module is oriented towards the rack. A control system is configured to monitor the item of food within the cooking chamber with image data captured by the imager module, and classify a browning of the item of food from a list of classifications including at least correct browning and uneven browning. If the item of food is classified as uneven browning, a positional alert is generated to the user to change a position of the item of food within the cooking chamber.

According to another aspect, a positional alert includes a recommendation to change a rack level of an item of food.

According to yet another aspect, a positional alert includes a recommendation to change a position of an item of food on at least one rack.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking appliance, comprising:
a body defining a cooking chamber;
a sensor monitoring the cooking chamber; and
a control system configured to:
monitor an item of food within the cooking chamber with the sensor;
classify a browning of the item of food from a list of classifications including at least correct browning and incorrect browning; and
if the item of food is classified as incorrect browning, generating one of a cycle alert to a user to change an aspect of a cooking cycle, a positional alert to the user to change a position of the item of food within the cooking chamber, or a signal to automatically change the aspect of the cooking cycle.

2. The cooking appliance of claim 1, wherein the control system is configured to generate the cycle alert to the user to change the aspect of the cooking cycle.

3. The cooking appliance of claim 2, wherein the aspect of the cooking cycle includes increasing a temperature within the cooking chamber.

4. The cooking appliance of claim 2, wherein the aspect of the cooking cycle includes decreasing a temperature within the cooking chamber.

5. The cooking appliance of claim 1, wherein the control system is configured to generate the positional alert to the user to change the position of the item of food within the cooking chamber.

6. The cooking appliance of claim 5, wherein the positional alert further includes a recommendation to change a rack level of the item of food.

7. The cooking appliance of claim 5, wherein the positional alert further includes a recommendation to change a position of the item of food on a rack.

8. The cooking appliance of claim 1, wherein the control system is configured to generate the signal to automatically change the aspect of the cooking cycle.

9. The cooking appliance of claim 8, wherein the signal includes instructions to automatically increase a temperature within the cooking chamber.

10. The cooking appliance of claim 8, wherein the signal includes instructions to automatically decrease a temperature within the cooking chamber.

11. The cooking appliance of claim 1, wherein the incorrect browning classification includes premature browning and late browning.

12. The cooking appliance of claim 1, wherein the incorrect browning classification includes uneven browning.

13. The cooking appliance of claim 12, wherein, if the item of food is classified as uneven browning, the control system is configured to generate the positional alert to the user to change the position of the item of food within the cooking chamber.

14. A cooking appliance, comprising:
a body defining a cooking chamber;
an imager module oriented towards the cooking chamber;
a user interface for selecting a cooking cycle; and
a control system configured to:
receive the cooking cycle selected by the user interface;
receive a classification of an item of food from the cooking cycle selected by the user interface or based on images captured by the imager module;
select an optimal cooking cycle based on the classification of the item of food;
compare the optimal cooking cycle with the cooking cycle selected by the user interface; and
if the comparison between the optimal cooking cycle and the cooking cycle selected by the user interface is outside of a predetermined threshold associated with browning, generating one of a cycle alert to a user to change an aspect of a cooking cycle or a signal to automatically change the aspect of the cooking cycle.

15. The cooking appliance of claim 14, wherein the cycle alert to the user includes a recommendation to adjust a time of the cooking cycle.

16. The cooking appliance of claim 14, wherein the cycle alert to the user includes a recommendation to adjust a temperature within the cooking chamber.

17. The cooking appliance of claim 14, wherein the signal to automatically change the aspect of the cooking cycle includes at least one of adjusting a time of the cooking cycle, adjusting a temperature within the cooking chamber, adjusting an airflow within the cooking chamber, or selecting a cooking type.

18. A cooking appliance, comprising:
a body defining a cooking chamber with at least one rack for holding an item of food;
an imager module oriented towards the rack; and
a control system configured to:
monitor the item of food within the cooking chamber with image data captured by the imager module;
classify a browning of the item of food from a list of classifications including at least correct browning and uneven browning; and
if the item of food is classified as uneven browning, generating a positional alert to the user to change a position of the item of food within the cooking chamber.

19. The cooking appliance of claim 18, wherein the positional alert includes a recommendation to change a rack level of the item of food.

20. The cooking appliance of claim 18, wherein the positional alert further includes a recommendation to change a position of the item of food on the at least one rack.
